(19) United States
(12) Patent Application Publication
(10) Pub. No.: US 2014/0358594 A1
(43) Pub. Date: Dec. 4, 2014

(54) TECHNIQUES FOR AIRPORT CHECK-IN

(71) Applicant: NCR Corporation, Duluth, GA (US)

(72) Inventor: Stavros Antonakakis, Lake Mary, FL (US)

(21) Appl. No.: 13/906,395

(22) Filed: May 31, 2013

(51) Int. Cl. G06Q 10/02

(52) U.S. Cl. CPC G06Q 10/02
USPC 705/5

(57) ABSTRACT

Techniques for airline check-in are provided. A passenger checks in for a flight using a government issued form of identification. A visual check-in confirmation is performed by security personnel. No electronic or printed boarding pass is issued to the passenger. The passenger proceeds to the gate for his/her flight and swipes at a kiosk the government issued form of identification to complete the boarding process.

### BACKGROUND

Consumers are increasingly using kiosks to conduct business with enterprises. The kiosks come in a variety of sizes and are used for a variety of purposes. Some kiosks are drive through, such as fast food establishments, pharmacies, banks, and the like. Other kiosks are stationary located in gas stations, airlines, grocery stores, department stores, and the like.

In addition, what is considered a kiosk is evolving with today's technology. For example, a user can use his/her phone as a form of a kiosk.

Consider a passenger boarding process, where a user can activate an onsite kiosk to check-in when entering the airport or can use a web-based or phone-based application to check-in electronically. The kiosk can be a standalone device at the airport or the user's phone.

In fact, the airline boarding process for a passenger has three main components: a) a successful check-in by the passenger, b) a generation of a paper or electronic boarding pass, and c) the passenger provides the boarding pass at the gate to be scanned confirming his/her flight boarding.

Paper boarding passes are the primary format used today although there has been a steady increasing trend towards electronic boarding passes in the form of scanned mobile boarding passes and other electronic boarding pass options, such as Apple Passbook™.

Although the boarding process seems automated in many respects, for the frequent business traveler the boarding process remains a very painful and tiring process for the traveler that has to be in and out of planes, cities, and customer business meetings day-in and day-out. The frequent traveler wants to spend the least amount of time in the airport so any opportunity to simplify the travel process: to shorten the traveler's journey, to simply the traveler's journey, and/or to make it less inconvenient for the traveler is welcomed.

### SUMMARY

In various embodiments, techniques for airport check-in are presented. According to an embodiment, a method for airport check-in is provided.

Specifically, information is scanned from a government issued identification card and passenger details for a passenger that is associated with the government issued identification card are retrieved. Next, the passenger is checked-in for a flight with a particular airline based on the passenger details.

### BRIEF DESCRIPTION OF THE DRAWINGS

FIG. 1 is a diagram of a method for airport check-in, according to an example embodiment.

FIG. 2 is a diagram of another method for airport check-in, according to an example embodiment.

FIG. 3 is a diagram of an airport check-in system, according to an example embodiment.

### DETAILED DESCRIPTION

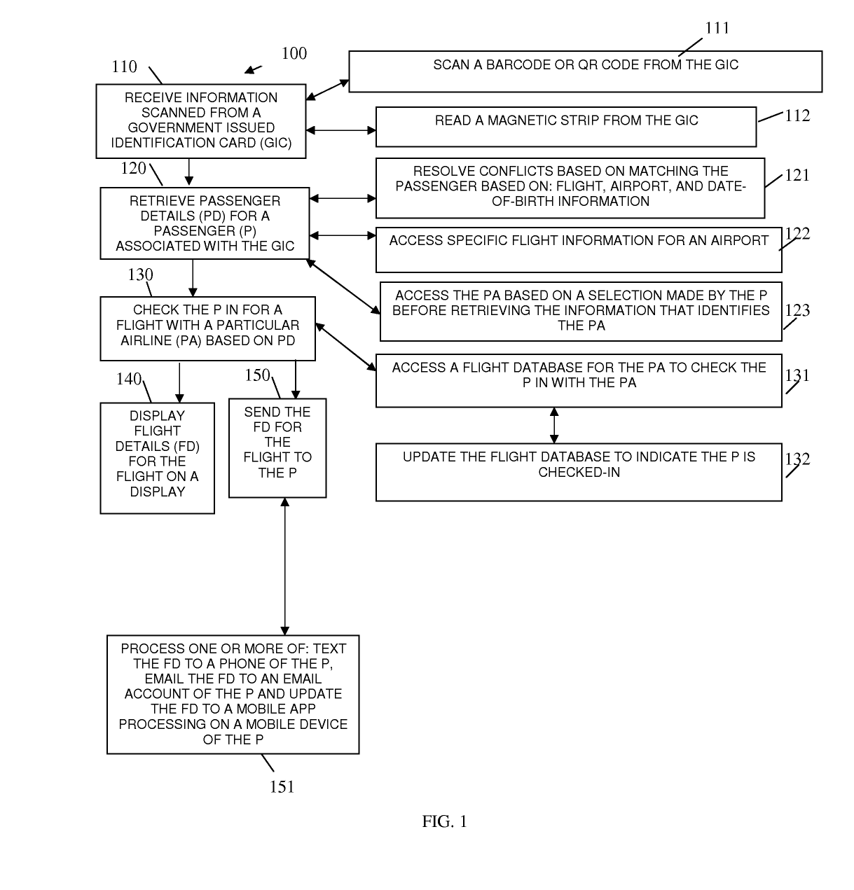

FIG. 1 is a diagram of a method 100 for airport check-in, according to an example embodiment. The method 100 (hereinafter “airline checking manager”) is implemented as instructions programmed and residing on a non-transitory computer-readable (processor-readable) storage medium and executed by one or more processors of a device. The processors are specifically configured and programmed to process the airline checking manager. The airline checking manager operates over a network. The network is wireless.

Initially, some example processing and situations are presented to illustrate the airline checking manager.

Essentially, the airline checking manager is a simplification of a passenger's boarding process from the time he/she gets to an airport by removing a need to carry any type of boarding pass and letting he/she get from the check-in all the way through boarding a play with just a government issued identification card, such as but not limited to a driver's license, passport, and others.

A sample situation using a driver's license of a passenger is accomplished as follows:

First, a passenger checks in for a flight via commonly available processes: web, kiosk, or mobile check-in using a form of identification. Secondly, a visual check-in confirmation of the boarding details is provided for each leg checked-in (details include gate, board time, seat assignment, special service requests (SSRs)). Optionally, the airline checking manager sends an email confirmation. There is no physical boarding pass(es) printed on successful check-in. Next, the passenger proceeds gate-side after being screened by the Transportation Security Administration (TSA). Then, the passenger proceeds to his/her gate for boarding, swiping his/her driver's license—getting a visual reminder of his/her seat and board the plane. Optionally, if the passenger forgets his/her gate or wants to verify if there has been a change, the airport is equipped with simple low cost kiosks with a card reader where he/she can re-swipe his/her driver's license and are provided with “temporarily and contextually pertinent information”—where his/her gate is, his/her seat assignment, and how long before the gate is closed.

Two issues to resolve with not having a boarding pass is: 1) the boarding pass artifact provides the passenger boarding details that he/she can refer to wherever and whenever; and 2) uniqueness—names are often common while boarding passes are unique.

Printers and consumables at the airport for the domestic U.S. traveler are eliminated with the teachings herein; the airport can instead equip lower cost kiosks with card readers and a screen that are readily available gate side and connected to the airport and airline's network. This provides a simple to use application that provides the passenger the most pertinent information he/she needs at that time and location. The airline checking manager can make use of the passenger's current location and itinerary details to know what the passenger must do next and how long he/she has for example. The kiosk can also help the passenger along by suggesting he/she hurry up so as to not to miss his/her flight and optionally, informing the airline agent gate side that a passenger is running late via the gate agent's software (all networked).

Moreover, the uniqueness challenge of swiping a driver's license and getting multiple matches on the airline's or airport's flight database can be solved by also including additional contextual information in the search that helps narrow the search. When multiple passenger names are found, some simple criteria to filter on include:—match on a passenger that is checked-in for a flight—match on the passenger that is checked for a flight at the current airport—match on the passenger by DOB (if available), etc.

In the case where even after the filtering, the passenger cannot be found, the transaction can be referred out to a travel agent. It is noted that while the simpler option might be to simply store and compare the driver's license number, the approaches herein do not require recording the driver's license data in the passenger's reservation. There are simple kiosks gate side equipped with a card reader where travelers can swipe their driver's licenses identification.

With this in mind, the airline checking manager is now discussed with reference to the FIG. 1.

At 110, the airline checking manager receives information scanned from a government issued identification card, such as but not limited to a driver's license, a passport, and others.

According to an embodiment, at 111, the airline checking manager scans a barcode or a Quick Response (QR) code from the government issued identification card.

In another case, at 112, the airline checking manager reading a magnetic strip from the government issued identification card.

In still other situations, the airline checking manager uses a Radio Frequency (RF) reader, a Near-Field Communication (NFC) reader, a Bluetooth reader, and/or a Low Energy Bluetooth reader to read the government issued identification card.

At 120, the airline checking manager retrieves passenger details for a passenger associated with the government issued identification card. The passenger details include information collected by airlines and/or TSA for passengers that are flying on an airline.

In an embodiment, at 121, the airline checking manager resolves conflicts based on matching the passenger based on: flight, airport, and date-of-birth information using a name acquired from the government issued identification card.

In still another case, at 122, the airline checking manager accesses specific flight information for an airport. That is, the flight details are captured and available on a per-airline basis.

In another situation, at 123, the airline checking manager accesses the particular airline based on a selection made by the passenger before receiving information that identifies the particular airline.

At 130, the airline checking manager checks the passenger in for a flight with a particular airline based on the passenger details.

According to an embodiment, at 131, the airline checking manager accesses a flight database for the particular airline to check the passenger in with the particular airline.

Continuing with the embodiment of 131 and in another embodiment, at 132, the airline checking manager updates the flight database to indicate the passenger is checked in.

In an embodiment, at 140, the airline checking manager displays flight details for the flight on a display. It is noted that the airline checking manager can be accessible via multiple kiosks such that the passenger can access a variety of devices and kiosks while at the airport to acquire the functions of the airline checking manager, some of which provides details to the passenger for their flight.

In another case, at 150, the airline checking manager sends the flight details for the flight to the passenger.

Continuing with the embodiment of 150 and in another embodiment at 151, the airline checking manager sends the flight details via one or more of: a text of the flight details to a phone of the passenger, an email of the flight details to an email account of the passenger, and an update of the flight details to a mobile app that processes on a mobile device of the passenger.

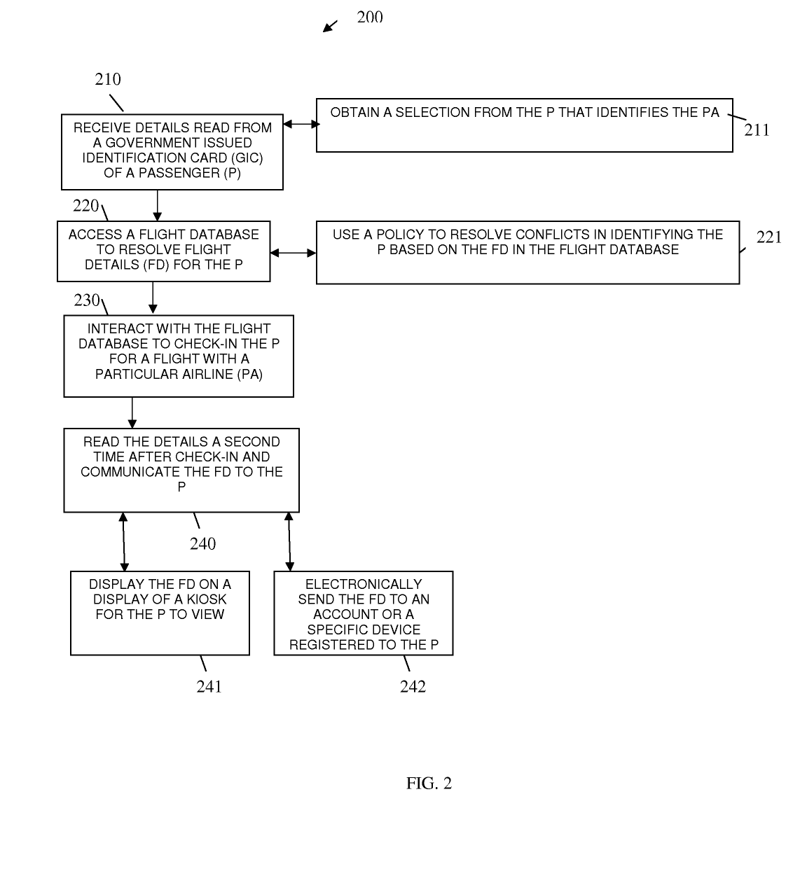

FIG. 2 is a diagram of another method 200 for airport check-in, according to an example embodiment. The method 200 (hereinafter “airport check-in controller”) is implemented as instruction and programmed within a non-transitory computer-readable (processor-readable) storage medium that executes on one or more processors of devices, servers, clouds, or sets of devices; the processors of these devices are specifically configured to execute the airport check-in controller. The airport check-in controller is also operational over a network; the network is wired, wireless, or a combination of wired and wireless.

The airport check-in controller presents another and in some instances an enhanced perspective of the airline check-in manager described above with reference to the FIG. 1.

At 210, the airport check-in controller receives details read from a government issued identification card.

According to an embodiment, at 211, the airport check-in controller obtains a selection from the passenger that identifies the particular airline. In other words, the airport check-in controller acquires with the government issued identification card details a selection for the airline made by the passenger at a kiosk device within the airport.

At 220, the airport check-in controller accesses a flight database to resolve flight details for the passenger.

In an embodiment, at 221, the airport check-in controller uses a policy to resolve conflicts in identifying the passenger based on the details and the flight database.

At 230, the airport check-in controller interacts with the flight database to check-in the passenger for a flight with a particular airline.

In an embodiment, at 240, the airport check-in controller reads the details a second time after check-in and communicates the flight details to the passenger.

Continuing with the embodiment of 240 and in another embodiment at 241, the airport check-in controller displays the flight details on a display of a kiosk for the passenger to view.

Still continuing with the embodiment of 240 and in another embodiment at 242, the airport check-in controller electronically sends the flight details to an account or a specific device registered to the passenger.

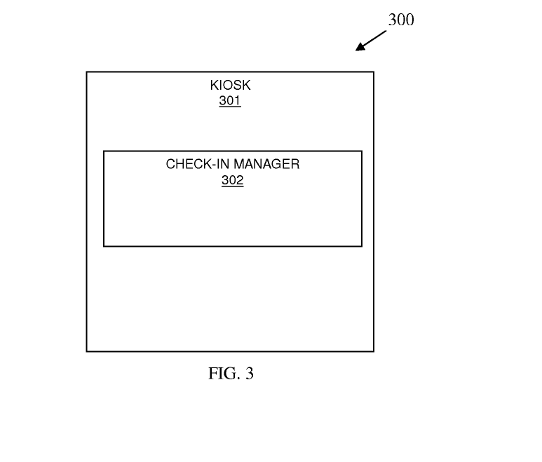

FIG. 3 is a diagram of an airport check-in system 300, according to an example embodiment. The components of the airport check-in system 300 are implemented as executable instructions and programmed within a non-transitory computer-readable (processor-readable) storage medium that execute on one or more processors of a kiosk; the processors of the kiosk are specifically configured to execute the components of the airport check-in system 300. The airport check-in system 300 may also be operational over a network; the network is wired, wireless, or a combination of wired and wireless.

The airport check-in system 300 includes a kiosk 301 and an airline check-in manager 302. Each of these components and the interactions of each component are now discussed in turn.

The airport check-in system 300 includes a kiosk 301 having one or more processors, memory, and/or storage. The kiosk 301 includes an input mechanism for retrieving details from a government issued identification of a user.

The kiosk 301 is configured to read a government issued identification card from a passenger to obtain passenger details. The passenger details are passed to the check-in manager 302.

The kiosk 301 includes memory and/or non transitory media having the airline check-in manager 302, which executes as executable instructions on the processors of the kiosk 301 and/or other devices (such as server, cloud, etc.). Example processing associated with the airline check-in manager was presented in detail above with reference to the FIGS. 1 and 2.

The airline check-in manager 302 is configured to interact with a flight database of an airport to resolve the passenger and to check the passenger in for a flight with a particular airline.

According to an embodiment, the check-in manager 302 is configured to check-in and board the passenger for the flight with the particular airline without issuing any printed or any electronic boarding pass to the passenger.

In another case, the check-in manager 302 is configured to interact with other kiosks dispersed throughout the airport to provide flight details to the passenger on demand.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A processor-implemented method programmed in a non-transitory processor-readable medium and to execute on one or more processors of a device configured to execute the method, comprising:
receiving, at the device, information scanned from a government issued identification card;
retrieving, by the device, passenger details for a passenger associated with the government issued identification card; and
checking, from the device, the passenger in for a flight with a particular airline based on the passenger details.

2. The method of claim 1 further comprising, displaying, from the device, flight details for the flight on a display.

3. The method of claim 1 further comprising, sending, from the device, flight details for the flight to the passenger.

4. The method of claim 3, wherein sending further includes one or more of: texting the flight details to a phone of the passenger, emailing the flight details to an email account of the passenger, and updating the flight details to a mobile app processing on a mobile device of the passenger.

5. The method of claim 1, wherein receiving further includes scanning a barcode or a Quick Response (QR) code from the government issued identification card.

6. The method of claim 1, wherein receiving further includes reading a magnetic strip from the government issued identification card.

7. The method of claim 1, wherein retrieving further includes resolving conflicts based on matching the passenger based on: flight, airport, and date-of-birth information.

8. The method of claim 1, where retrieving further includes accessing specific flight information for an airport.

9. The method of claim 1, wherein retrieving further includes accessing the particular airline based on a selection made by the passenger before receiving the information that identifies the particular airline.

10. The method of claim 1, wherein checking further includes accessing a flight database for the particular airline to check the passenger in with the particular airline.

11. The method of claim 10, wherein checking further includes updating the flight database to indicate the passenger is checked in.

12. A processor-implemented method programmed in a non-transitory processor-readable medium and to execute on one or more processors of a device configured to execute the method, comprising:
receiving, on the device, details read from a government issued identification card of a passenger;
accessing, via the device, a flight database to resolve flight details for the passenger; and
interacting, via the device, with the flight database to check-in the passenger for a flight with a particular airline.

13. The method of claim 12 further comprising, reading the details a second time after check-in and communicating the flight details to the passenger.

14. The method of claim 13, wherein communicating further includes displaying the flight details on a display of a kiosk for the passenger to view.

15. The method of claim 13, wherein communicating further includes electronically sending the flight details to an account or a specific device registered to the passenger.

16. The method of claim 12, wherein receiving further includes obtaining a selection from the passenger that identifies the particular airline.

17. The method of claim 12, wherein accessing further includes using a policy to resolve conflicts in identifying the passenger based on the flight details and the flight database.

18. A system comprising:
a kiosk; and
the kiosk having memory configured with a check-in manager that executes on one or more processors of the kiosk;
wherein the kiosk is configured to read a government issued identification card from a passenger to obtain passenger details, the passenger details passed to the check-in manager, and wherein the check-in manager is configured to interact with a flight database of an airport to resolve the passenger and to check the passenger in for a flight with a particular airline.

19. The system of claim 18, wherein the check-in manager is configured to check-in and board the passenger for the flight with the particular airline without issuing any printed or any electronic boarding pass to the passenger.

20. The system of claim 18, wherein the check-in manager is configured to interact with other kiosks dispersed throughout the airport to provide flight details to the passenger on demand.
